(19) United States
(12) Patent Application Publication
(10) Pub. No.: US 2002/0164026 A1
(43) Pub. Date: Nov. 7, 2002

(54) An authentication method

(76) Inventor: Antti Huima, Espoo (FI)

Correspondence Address: ALTERA LAW GROUP L.L.C, 10749 BREN ROAD EAST, OPUS 2, MINNEAPOLIS, MN, 55343, US

(21) Appl. No.: 09/913,194

(22) Filed: Aug. 9, 2001

Related U.S. Application Data
(63) Continuation of application No. PCT/EP00/01076, filed on Feb. 10, 2000.

(30) Foreign Application Priority Data
Feb. 11, 1999 (GB) 9903124.7

(51) Int. Cl. H04K 1/00

(52) U.S. Cl. 380/247; 380/273; 713/171

(57) ABSTRACT

An authentication method for authenticating communication between a first and a second party using a third party which is trusted by said first and second parties comprising the steps of calculating by the trusted third party the value of a first authentication output using a parameter of the first party and a second authentication output using the first authentication output and sending the second authentication output to the second party; calculating by the first party the first authentication output and sending the first authentication output to the second party; and calculating by the second party the second authentication output based on the first authentication output received from the first party and comparing the calculated second authentication output with the second authentication output received from the trusted third party whereby if the two second authentication outputs are the same, the first party is authenticated.

The present invention relates to an authentication method for use for example, but not exclusively, in wireless cellular telecommunication networks and also to a system using this method.

A typical cellular wireless network 1 is shown in FIG. 1. The area covered by the network is divided into a number of cells 2. Each cell 2 is served by a base transceiver station 4 which transmits signals to and receives signals from terminals 6 located in the respective cell associated with a particular base transceiver station 4. The terminals may be mobile stations which are able to move between cells 2. As the transmission of signals between the terminal 6 and the base transceiver stations 4 is via radio waves, it is possible for unauthorised third parties to receive those signals.

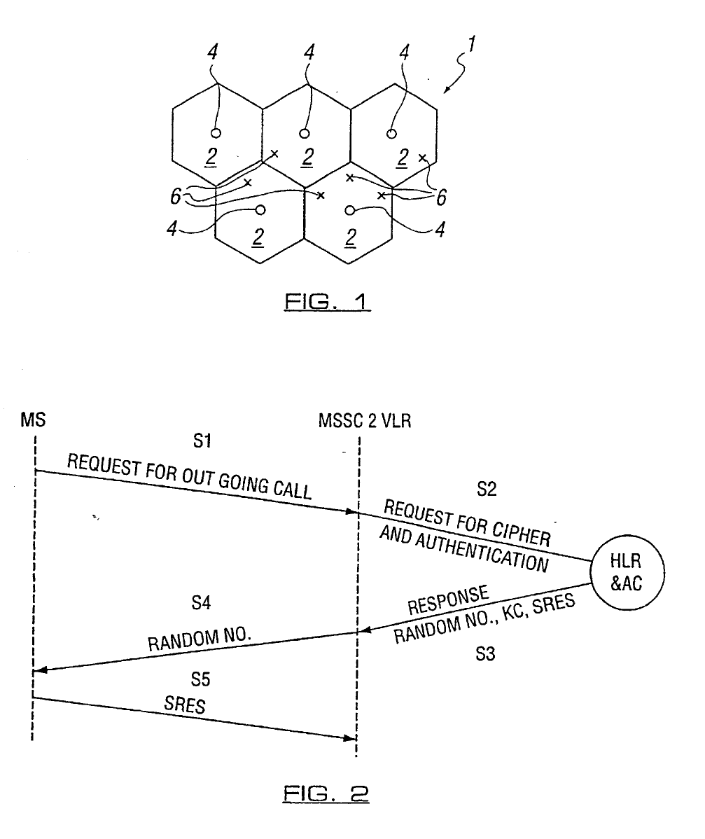

Accordingly, in known wireless cellular networks, authentication is provided to identify the right mobile and ciphering is used to prevent third parties from listening in. Illustrated in FIG. 2 is the procedure carried out in the GSM (Global System for Mobile communications) standard. In the first step S1, the mobile station MS makes a request to a mobile services switching centre (MSSC) via the base station for an outgoing call. A visitor location register (VLR) is informed via the mobile services switching centre of this request. The VLR takes control of the authentication procedure.

Each mobile terminal is provided with an identification number which is sometimes referred to, in a GSM standard, as the IMSI (International mobile subscriber identity) number. The MSSC forwards the mobile's IMSI to the VLR. Information on the IMSI is initially provided by the mobile station. The VLR then sends, in the second step S2, the IMSI together with the identity of the VLR to the home location register HLR of the mobile. This ensures that any incoming calls can be directed to the mobile station at its current location. Once the HLR has received the IMSI, a request is made to an authentication centre AC for the mobile subscriber's ciphering key KI. The ciphering key KI is present at both the authentication station AC as well as the mobile station.

In a third step S3, the authentication centre uses the cipher key KI and a random number to generate a signature SRES and a ciphering key Kc which is used for channelling coding. The random number, the ciphering key Kc and the signature SRES make up a triplet which is only used for a single communication. Each triplet calculated by the authentication centre AC is forwarded to the associated visitor location register VLR and the mobile services switching centre MSSC.

In step S4, the VLR conveys the value of the ciphering key Kc to a base station controller (not shown) and the value of the random number to the mobile station.

The mobile station then calculates a signature SRES based on the same algorithm used by the authentication centre and that signature is, in step S5, transmitted to the VLR. The signature generated in the mobile station is based on the mobile subscribers ciphering key KI and the random number which it receives from the VLR. Authentication is considered to be complete when the signature SRES generated by the mobile station is the same as that generated by the authentication centre AC. Once the authentication procedure has been completed, data which is transmitted is ciphered using the ciphering key Kc and a temporary mobile subscriber identity (TMSI) which is provided by the VLR to the mobile station in encoded form.

It is an aim of embodiments of the present invention to improve the authentication procedure and thus make communications more secure.

According to one aspect of the present invention, there is provided an authentication method for authenticating communication between a first and a second party using a third party which is trusted by said first and second parties comprising the steps of calculating by the trusted third party the value of a first authentication output using a parameter of the first party and a second authentication output using the first authentication output and sending the second authentication output to the second party; calculating by the first party the first authentication output and sending the first authentication output to the second party; and calculating by the second party the second authentication output based on the first authentication output received from the first party and comparing the calculated second authentication output with the second authentication output received from the trusted third party whereby if the two second authentication outputs are the same, the first party is authenticated.

The method may comprise the steps of calculating by the first party the value of the second authentication output, sending the value of the second authentication output calculated by the trusted third party to said first party and comparing at the first party the calculated value of the second authentication output calculated by the first party and the value of the second authentication output connected by the third party whereby the second party is authenticated.

Preferably, the value of the second authentication output calculated by the trusted third party is sent to the first party by the second station.

Preferably at least one and more preferably both of the first and second authentication outputs are the outputs of a hash function. The use of a double hash function is particularly advantageous in providing a secure method of communication.

Both of the first and second hash function are preferably one way. This means that it is virtually impossible for a third party to determine the value of the at least one parameter. Preferably, at least one of the hash functions has a value of at least 160 bits in length. The value of the hash function may of course be longer or shorter. However, the longer the hash function, the harder it is for it to be deciphered by an authorised party.

It is preferably that the probability that an unauthorised party be able to guess the value of at least one of said hash function be of the order of at most 1/2¹⁶⁰. In other words, the probability of guessing the value of the hash function is negligible if at least one parameter is unknown. Again, this improves the security of the communication between the parties.

Preferably, one of the outputs includes a secret which is shared by the first and second parties. It is preferable that this secret be known only to the first and second parties. Preferably, the secret comprises a Diffie-Hellman function.

Preferably, the shared secret is used by at least one party for encrypting communications between the first and second parties. This allows the communications between the first and second parties to be secure.

Preferably, the shared secret is g^{xy}mod n where the Diffie-Hellman function, x and y are random numbers and n is the modulus of the Diffie-Hellman function.

Preferably, at least one random number is used to encrypt communications between the first and second parties. This may be in addition or as an alternative to the shared secret. Preferably, re-keying of an encryption function occurs when the at least one random number is changed.

The value of at least one parameter is preferably sent from the first station to the second station. Likewise, it is preferred that the value of at least one parameter be sent from the second station to the first station. This allows information to be exchanged between the parties and, for example, allow the calculation of the shared secret.

The trusted further party preferably has a secure connection with the second party.

Preferably the identity of at least one party is only sent to the other party in an encoded form. For example, the identity may be included within one of the first and second authentication outputs. Alternatively the identity may be sent in a separately encrypted form. Since the identity of a party is important in retaining secure communication, it is important that unauthorised third parties be not be able to obtain any identity of the first or the second party.

Preferably, the method is used in a telecommunications network which may be wired or a wireless network. One of the first and second parties may be a mobile station whilst the other may be a base station.

According to a second aspect of the present invention, there is provided an authentication method for authenticating communication between a first and a second party comprising the steps of calculating the value of a first hash function of a second hash function using at least one parameter; sending the calculated value of the first hash function of the second hash function from the first party to the second party, said second party being provided with a separately calculated value of the first hash function of the second hash function using the same at least one parameter; and comparing the value of the first hash function of the second hash function received from the first party with the separately calculated value of the first hash function of the second hash function, whereby if the two values are the same, the first party is authenticated.

For a better understanding of the present invention and as to how the same may be carried into effect, reference will now be made by way of example to the accompanying drawings in which:

FIG. 1 shows a known cellular network in which embodiments of the present invention can be used;

FIG. 2 shows a known authentication protocol;

FIG. 3 illustrates a key exchange using signatures embodying the present invention;

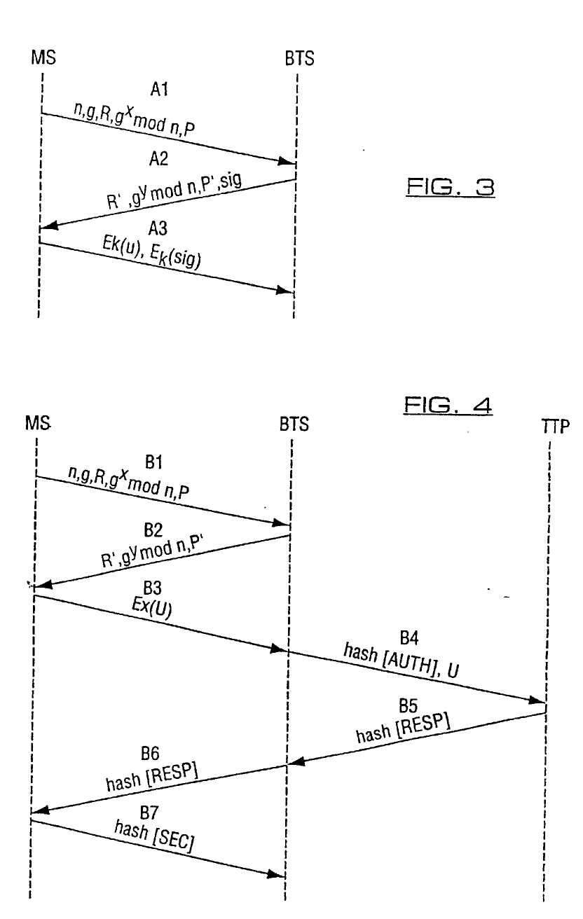

FIG. 4 illustrates a key exchange using a trusted third party embodying the present invention;

FIG. 5 illustrates a key exchange without using the identity of the mobile station, embodying the present invention;

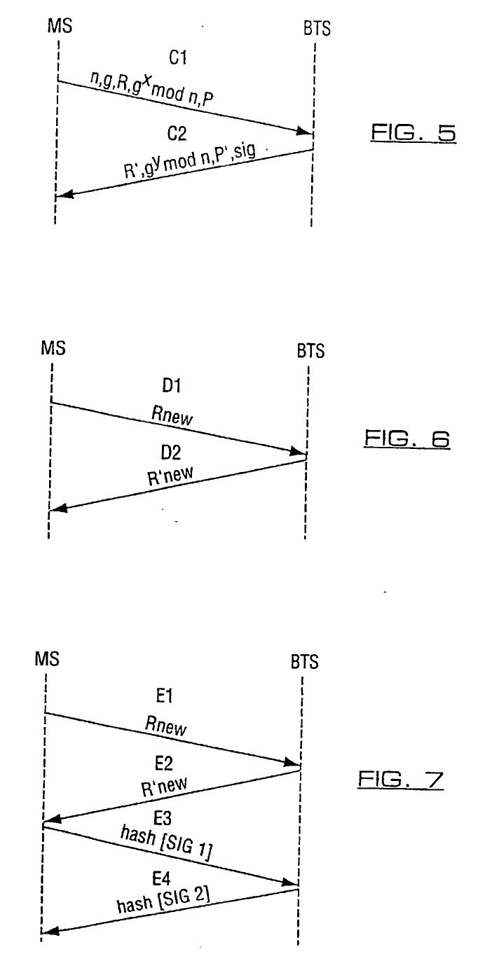

FIG. 6 illustrates rekeying without re-authentication, embodying the present invention;

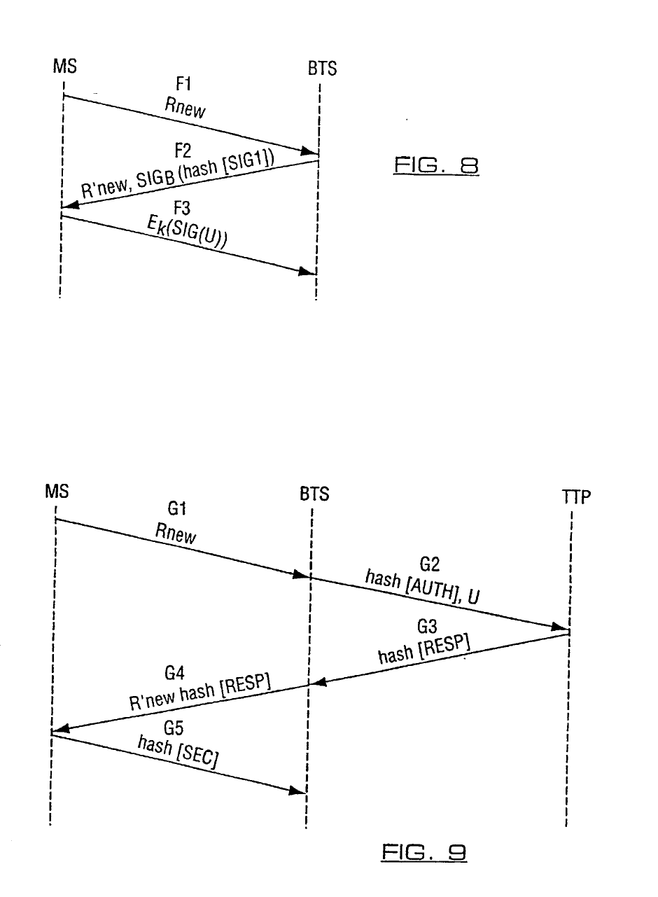

FIG. 7 illustrates rekeying with shared secret authentication, embodying the present invention;

FIG. 8 illustrates rekeying with a signature authentication embodying the present invention;

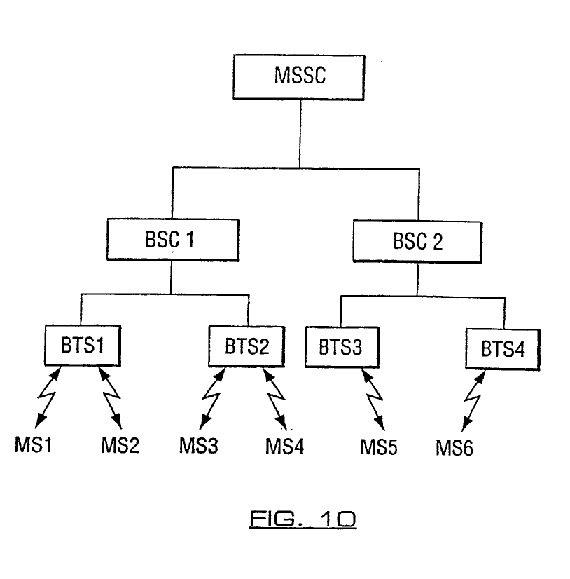

FIG. 9 illustrates rekeying using third party authentication embodying the present invention; and

FIG. 10 shows part of the hierarchy of the network shown in FIG. 1.

In order to assist with the understanding of embodiments of the present invention, a summary of some of the abbreviations used is now provided.

U—UMTS (Universal Mobile Telecommunication Service) user identity, sometimes referred to as IMUI (International Mobile User Identity). In other words, U represents the identity of the mobile station.

n—modulus of Diffie-Hellman key exchange and is typically a large prime number. In other words, this represents the modular arithmetic which is used. Modular arithmetic is a circular type of counting so that for any results obtained, the results themselves are not used. Instead the remainder when divided by the modulus n is used.

g—generator of Diffie-Hellman key exchange. g can be any suitable integer between 2 and n−1 inclusive.

x, y—random exponents used in the Diffie-Hellman key exchange in other words, g is raised to the power of x and/or y.

R, R′—random numbers, also referred to as nonces. Typically these random numbers are changed regularly.

P, P′—security parameters—which include information as to the available ciphers, hash functions etc.

SIG_{A}(φ)—signature SIG of φ by A's signature key.

Eₖ(φ)—φ encrypted using key k

hash[X] (φ)—parametrized hash function with a constant parameter X. In other words, the hash function varies in accordance with a given parameter X. The value of the parameter can of course vary.

φ|X—concatenation (i.e. putting two items together one after the other) of φ and X.

φ,X—concatenation of φ and X.

Embodiments of the present invention use signature functions SIG having the following features. SIG_{A}(φ) should only be computable by A and principals authorised by A only, assuming that φ has previously been chosen and φ has not previously been signed. In order for the signature function SIG_{A}(φ) for a previously chosen φ, to be effective against unauthorised persons, the complexity of the problem confronting an unauthorised person should be 2¹⁶⁰ or greater. Additionally, the signature should be verifiable by all parties who possess the corresponding verification function. The verification function is sometimes referred to as the verification key.

If X is a suitable parameter for the parametized hash function used in the protocols described hereinafter, the following features will be provided by the hash function. The length of the returned value of the hash function should be at least 160 bits in order to prevent birthday attacks. In other words, the likelihood of hash X equalling hash Y is low so the probability of a third party being able to obtain access by trying out some of the possible values is very small. The function should be a one way keyed function. The hash function should have a large domain i.e. set of possible values whose size is equal to 2¹ where 1 is at least 160. The amount of work required to compute the value of y from hash[X] (y)=z if z is known should have an order of complexity equal to 2¹ where 1 is the length of the output of the hash function in bits and 1 is at least 160. Knowing the value of z should not put the attacker in a better position to determine hash [x] (i) than if he did not know that value. If the value of the function hash[X] (S|y₁) is known for i which belongs to the set 1, 2, . . . K, and yᵢ is known but it is only known that S is only one possible value, then the probability of being able to guess the value for hash[X] (S|x) for some x should be 1/O(min(2¹, |Q|)) where O represents “order of” and Q is the set from which a particular value of the secret S used in the keyed hash function is picked from. For example, if the secret S used in the keyed hash function is a 40 bit random number then Q is the set of all 40-bit random numbers. |Q| represents the size of the set. “min” selects the minimum of 2¹ and |Q|.

X determines the hash function and because X only determines the functions used it does not need to be secret. Indeed, the parameters X may be publicly known and fixed for a long period of time.

The protocols which will be described hereinafter are used to perform key exchange, key reexchange and mutual authentication. In summary, the mobile station MS and the network or base transceiver station BTS perform an initial key exchange protocol in order to obtain a shared secret S as a result of a Diffie-Hellman key exchange. This shared secret S is g^{xy}mod n The parties also exchange a pair of random numbers R, R′. The concatenation of the shared secret S and the two nonces provide the key material. Different keys are derived from key material using different parametrized hash functions. Rekeying is performed by exchanging a new pair of random numbers.

Keys for encrypting further communications can also be created using the following formula: k=hash[T] (g^{xy}mod n|R|R′) where T is a unique parameter. T can be public or fixed and can be used once or more than once.

During the initial key exchange protocol, security parameters P are exchanged. These security parameters are used to inform the other party about the available ciphers, hash functions etc.

Diffie-Hellman key exchange is a way to establish a shared secret between two parties. When using modular arithmetic, it is very hard to compute the value of x when only g^{x} is known. Normally, computing x from g^{x} means computing the logarithm of g^{x} and this is easy. However, in modular arithmetic the situation changes dramatically; it is not known how to compute x from g^{x}.

In Diffie Hellman key exchange therefore two parties establish a shared secret in the following way. The first party sends “g^{x}”. The second party sends “g^{y}”. Here x is known only by the first party and y is known only by the second party. However the values g^{x} and g^{y} are public. Now the shared secret is g^{xy}. In order to compute g^{xy} you need to know at least one of the values of x and y. For example, if you know x, you can compute g^{xy} as (g^{y})^{x}. Computing discrete logarithms i.e. x from g^{x}, is very hard. Accordingly no-one else is able to compute g^{xy} even though the values g^{x} and g^{y} are public.

Reference will now be made to FIG. 3 which illustrates schematically a key exchange using signatures The purpose of this key exchange is to create the shared secret S=g^{xy}mod n to exchange the random numbers and to authenticate both parties.

In the initial communication, the mobile station MS sends to the base transceiver station a random number R along with public Diffie-Hellman key exchange parameters n and g and the public key g^{x}mod n. The mobile station also sends security parameters P to the base station. This first message from the mobile station MS to the base transceiver station initiates the key exchange and is illustrated in FIG. 3 in step A1.

The second message is sent from the base transceiver station BTS to the mobile station MS and constitutes the second step A2 illustrated in FIG. 3. The base transceiver station sends a random number R′ along with another public Diffie-Hellman key g^{y}mod n and security parameters P′ to the mobile station MS. The network then signs the key exchange and random numbers so that the mobile station can ascertain that the exchange went well without being attacked. This particular method prevents attacks known as man in the middle attacks. This is where a third party intercepts transmissions from a mobile station, substitutes information into that communication from the mobile station before transmitting to the base station and likewise intercepting communications for the mobile station which are received from the base station. The shared secret S=g^{xy} mod n must be included in the signature so that the mobile is sure that the base transceiver station knows the shared secret.

The signature SIG_{B} provided in the second message by the base transceiver station is as follows:

SIG_{B}(hash[SIG1] (n|g|g^{x}|g^{y}|g^{xy}|P|P′|R|R′|B))

B is the identity of the base transceiver station.

A temporary key k is computed from the shared secret and the random numbers. The random numbers are included in the temporary key so that rekeying can occur using the same shared secret. Rekeying occurs when a new temporary key is generated. As will be described in more detail hereinafter, rekeying can be achieved by providing new random numbers R and R′. The temporary key k is equal to hash[TKEY] (g^{xy}mod n|R|R′).

The mobile station carries out a verify function in respect of the signature SIG_{B}. The verify function and the signature function are related so that given the value of the signature function, the verify function provides an accept or reject value. Accept means that the signature is accepted and reject means that the signature is invalid. In other words the mobile station is arranged to verify the signature which it receives.

In step A3, the message which is sent from the mobile station MS to the base transceiver station is encrypted using the temporary key. In the encrypted message, the identity of the mobile user U is included. Thus, the identity of the user U is only sent in an encrypted form. The encrypted identity is represented by Eₖ(U). Along with the encrypted identity, the mobile station also sends a signature SIG_{U}, similar to that sent from the base transceiver station to the mobile station in step A2. However, that signature is encrypted. The encrypted signature is represented by the following:

Eₖ(SIG_{U}(hash[SIG2] (n|g|g^{x}|g^{y}|g^{xy}|P|P′|R|R′|B|U))).

As can be seen, the identity of the mobile user is included in the signature. Encryption of the signature is not essential although the mobile's identity is encrypted and it may be more convenient also to encrypt the signature. It should be appreciated that both of the signatures SIG_{B} and SIG_{U} include the signer's identity i.e. B and U respectively and the use of these identities in the signatures is to prevent third parties from stealing the signed hash values and signing them again with different keys. In other words, the inclusion of the identities B and U makes the functions unique to the base station and mobile station respectively.

The base transceiver station verifies the signature received from the mobile station in order to authenticate the mobile user in the same way that the mobile station verifies the base station. This may require a connection to the service provider of the mobile user.

Reference will now be made to FIG. 4 which illustrates a key exchange using trusted third parties. As with the key exchange using signatures, the purpose is to exchange random numbers and to authenticate both parties.

This protocol starts in the same way as the last one with the mobile station in step B1 sending the values of n, g, the random number R, g^{x}mod n and parameters P to the base transceiver station. The base transceiver station then sends the random number R′, g^{y}mod n and parameter P′ to the mobile station. A temporary key k is calculated from hash[TKEY] (g^{xy}mod n R|R′). Unlike the key exchange using signatures, the key exchange is not authenticated before the encryption is turned on. In the third step, B3, the user identity U is sent from the mobile station to the base transceiver station in an encrypted form Eₖ(U).

In the fourth step B4, the base transceiver station contacts a trusted third party TTP, for example a service provider of the user, using a connection which is assumed to be secure and authenticated. The base transceiver station BTS thus sends the trusted third party TTP a hash of the shared secret, the Diffie-Hellman public key parameters, the random numbers, the identity of the communicating parties and the security parameters. Thus, the base transceiver station BTS sends the following authenticating hash function to the trusted third party TTP:

hash[AUTH] (n|g|g^{x}|g^{y}|g^{xy}|P|P′|R|R′|B|U)

The identity of the mobile user U is already known by the trusted third party. This may be achieved in any suitable way.

In embodiments of the present invention, it is preferred to send the hash of g^{xy} rather than the encryption key k. As the encryption key k is probably shorter than g^{xy}, it is thus easier to attack. First shared secret data g^{xy} mod n is assumed to be shared by the base station and the mobile but by no-one else. There is a second, long term, shared secret between the base station and the mobile phone which is distributed offline. This long term secret may be in the SIM card of the mobile phone or the like. The first secret g^{xy} modn used to get a session key whilst the second secret is used so that the mobile phone is able to authenticate the base station.

In the fifth step B5, the trusted third party computes a hash of the secret from the shared secret data concatenated with hash [AUTH] which the base transceiver station sent thereto. A hash of the hash value calculated by the trusted third party is then calculated, again by the trusted third party. The trusted third party then sends this finally computed hash value to the base transceiver station which records this value. The value sent by the trusted third party to the base transceiver station is as follows:

hash[RESP] (hash[SEC] (S|hash[AUTH] (n|g|g^{x}|g^{y}|g^{xy}|P|P′|R|R′|B|U)))

The same value is then forwarded from the base transceiver station to the mobile station in the sixth step B6. The mobile station is able to compute the value of hash [SEC] directly. The mobile station then calculates hash [RESP] from hash [SEC] and thus compares the value of hash [RESP] (hash [SEC]) which it calculated with the value received from the trusted third party via the base transceiver station. If the two values of hash[RESP] (hash[SEC]) are the same, then the mobile knows that the home location register has authenticated the base transceiver station and the Diffie Hellman key exchange If the two values hash[RESP] (hash[SEC]) are not the same, this indicates that there is an authentication problem or a man in the middle attack.

Finally, in the seventh step, B7, the mobile station sends the value of hash[SEC]) without further hashing to the base station. The base transceiver checks whether or not hash [SEC] hashes to the same hash which the base station has received, i.e. hash[RESP]hash[SEC] from the trusted third party. If the value of hash[RESP]hash[SEC] received from the trusted third party is the same as that calculated by the base transceiver station, then the base transceiver station is able to determine that the mobile station was able to compute the correct hash [SEC] function and thus the mobile user is authenticated. At the same time, the Diffie-Hellman key exchange is also authenticated.

With both of the key exchanges described in relation to FIGS. 3 and 4, the Diffie-Hellman public parameters n and g can be left out of the first message if they are already known, for example if they are constants.

Reference will now be made to FIG. 5 which illustrates a key exchange without requiring the identity of the mobile user. The purpose of this procedure is to distribute the shared secret and the random numbers between the mobile station and the base transceiver station and to authenticate the network. However, the mobile user is not authenticated and in fact remains anonymous.

In the first step C1, the mobile station sends to the base transceiver station exactly the same information which is sent in the first step of the key exchange using signatures as well as the key exchange using the trusted third party which are shown in FIGS. 3 and 4.

The base station then, in step C2, sends to the mobile station the same information which is sent in the key exchange using signatures (FIG. 3) and also signs the information. With this key exchange, the base station cannot be as sure as to the identity of the mobile station with which it is communicating However, the signature by the base transceiver station ensures good key exchange. In other words, the unidentified mobile station can detect if there are any man in the middle of attacks and drop the connection if needed The base station is not able to detect man in the middle attacks but it does not need to. In particular, the base station will not transmit security critical information to an unidentified party anyway. This can be used for access to public networks such as the internet where the identity of the mobile is not required.

Reference will now be made to FIG. 6 which shows a simple rekeying procedure without requiring new authentication. The purpose of this protocol is to distribute new random numbers in order to perform rekeying.

Re-keying means that a new temporary key k for encryption purposes can be generated. To avoid the unauthorised deciphering of messages between the mobile station and the base station, rekeying should occur frequently.

In the first step D1, the mobile station sends to the base transceiver station the new random number R_{new}. In the second step D2, the base transceiver station transmits a second new random number R′_{new} to the mobile station. With this particular protocol, it is not necessary that the random numbers be kept secret. However, the integrity of the random numbers should be protected. In other words, the random numbers should not be modified during their transmission between the mobile station and the base transceiver station. This is for issues of quality and not security. It is of course possible that the order of the two steps D1 and D2 can be reversed.

A new temporary key k can be derived from the equation hash[T] (g^{xy}mod n|R|R′). Thus, the original shared secret can be used in determining the new key. This is possible as the original shared secret g^{xy}mod n has never been used as a key in itself. Thus, the new key will be secure even if the old keys using the old random numbers in combination with the common shared secret have been compromised. It should also be appreciated that this protocol is secure even if the identities of the new random numbers have become public. This is because with the hash function, even if the identities of the random numbers are known, it is not possible to derive the shared secret nor the key.

Reference will now be made to FIG. 7 which shows a rekeying procedure which authenticates the parties. In the first step E1, the mobile station sends the new random number R_{new} to the base transceiver station. In the second step E2, the base transceiver station sends a second new random number R′_{new} to the mobile station MS. In the third step E3, the mobile station sends a hash signature. to the base transceiver station having the following form: hash[SIG1] n|g|g^{x}|g^{y}|g^{xy}|P|P′|R_{new}|R′_{new}|B|U).

The base station will calculate the value of hash[SIG1] and compare it with the value of hash[SIG1] which it has received from the mobile station. If the values are the same, then the new random numbers are authenticated as is the mobile station.

In the fourth step E4, the base transceiver station provides a hash value to the mobile station of the following form: hash[SIG2] (n|g|g^{x}|g^{y}|g^{xy}|P|P′|R_{new}|R′_{new}|B). These values allows the random numbers to be authenticated by binding them to the current shared secret. The mobile station will verify the value of hash[SIG2] . If hash [SIG2] is verified, then the new random numbers are again authenticated as is the base station.

Reference is now made to FIG. 8 which shows a rekeying protocol using signature authentication In this procedure both parties are re-authenticated.

In the first step F1, the mobile station sends the new random number R_{new} to the base transceiver station. In the second step, F2, the base transceiver station sends the second new random number R′_{new} to the mobile station and signs a signature hash function as follows:

SIG_{B}(hash[SIG1] (n|g|g^{x}|g^{y}|g^{xy}|P|P′|R_{new}|R′_{new}|B))

The mobile station is able to calculate a new encryption key using these new random numbers as outlined hereinbefore. The mobile station is also able to authenticate the base station using a verification function.

The new encryption key k is therefore hash[TKEY] (g^{xy}mod n|Rnew|R′new). In the third step F3, the mobile station sends to the base transceiver station an encrypted signature of a hash function hash[SIG] having the following form: Eₖ(SIG_{U}(hash[SIG2] (n|g|g^{x}|g^{y}|g^{xy}|P|P′|R_{new}|R′_{new}|B|U))). The signature sent by the mobile station is encrypted. This is not essential but may be more convenient with other information needs to be encrypted. The encryption uses the new encryption key k. The base station is able to authenticate the mobile station by verifying the signature. If the verification function is accepted, the mobile station is authenticated.

Reference will now be made to FIG. 9 which shows rekeying using third party authentication. In the first step G1, the mobile station sends to the base station the identity of the new random number R_{new} In the second step G2, the base transceiver station sends to a trusted third party an authentication hash function hash[AUTH] (n|g|g^{x}|g^{y}|g^{xy}|P|P′|R_{new}|R′_{new}|B|U) along with the mobile identity U. The authentication hash function includes a second new random number R′new. As the connection between the base station and the trusted third party is secure, there is no need to encrypt the identity of the mobile station U. The trusted third party computes in the third step G3 a hash [RESP] of a hash of the shared secret S which includes the authentication hash function and the shared secret and sends this value to the base station. The authentication hash function is the same as that received from the base station.

In the fourth step G4, the base station sends to the mobile station the same value which the base station has received from. the trusted third party along with the value of the second new random number R_{new}. The mobile station computes the value of hash [SEC] using the new random number value and from that calculates a value for hash [RESP] The mobile station checks whether or not the value which it got from the base transceiver station is equal to the value which it has computed. As in the key exchange using trusted third parties described hereinbefore with reference to FIG. 4, if the values are the same, then the mobile station knows that the home location register has authenticated the base transceiver station and the key exchange.

The mobile station then sends in step GS the value of hash [SEC], without further hashing to the base transceiver station. The base transceiver station then checks whether hash[SEC] received from the mobile station hashes to the same value which the base transceiver station received from the trusted third party If it does, then the base transceiver station knows that the mobile was able to compute the hash[SEC] function and thus the user is authenticated.

In all of the rekeying processes described hereinbefore, the random numbers do not need to be kept secret.

As can be seen, there are 15 different messages that are used in the protocols. These messages are as follows:

1. n,g

2. R

3. R′

4. P

5. P′

6. g^{x}mod n

7. g^{y}mod n

8. n|g|g^{x}|g^{y}|g^{xy}|P|P′|R|R′|B

9. n|g|g^{x}|g^{y}|g^{xy}|P|P′|R|R′|B|U

10. SIG_{B}(hash[SIG1]n|g|g^{x}|g^{y}|g^{xy}|P|P′|R|R′|B)

11. Eₖ(SIG_{U}(hash[SIG2] (n|g|g^{x}|g^{y}|g^{xy}|P|P′|R|R′|B|U))

12. Eₖ(U)

13. hash[AUTH] (n|g|g^{xy}mod n|R|R′|B|U), U

14. hash[RESP] (hash[SEC]S|hash[AUTH] (n|g|g^{xy}mod n|R|R′|B|U))

15. hash[SEC] (S|hash[AUTH] (n|g|g^{xy}mod n|R|R′|B|U))

As it can be seen, some of these messages share a common structure namely messages 2 and 3, messages 4 and 5, and messages 6 and 7. This leaves a total of 12 different types of message. This protocol family is thus advantageous in that it allows a relatively large number of different protocols to be implemented using only a small number of different messages.

Thus, the various different methods outlined hereinbefore can define a family of methods made up of a limited number of messages. It is thus possible, in embodiments of the present invention, to select one of those methods. Various different criteria can be used in deciding which of the methods to use. For example, the different methods can be selected at random. A re-keying method may always be selected only if a key exchange method has been previously selected. The method may be selected depending on the processing capability of the first and/or second party (or the trusted third party when provided). The method can be selected in dependence on the amount of time since the last method was used. Alternatively, the method can be selected based on the function provided by the particular method eg, whether or not a trusted third party is used and whether or not authentication is required and if so what type of authentication.

In the arrangement described hereinbefore, the mobile station is described as communicating with the base transceiver station. It should be appreciated that the communication can in fact take place with any suitable element of the network although this communication will be via the base transceiver station. In other words, some of the calculations described as taking place in the base transceiver station in the preferred embodiments may take place in other parts of the network but will be transferred to the base transceiver station where appropriate. The mobile station can be replaced by any other suitable terminal whether fixed or mobile.

Embodiments of the invention can be used with any suitable wireless cellular telecommunications network. Reference will now be made to FIG. 10 which shows the network hierarchy. The base stations BTS 1-4 are in communication with respective mobile stations MS 1-6. In particular, the first base station BTS 1 is in communication with the first and second mobile stations MS 1 and 2. The second base station BTS 2 is in communication with the third and fourth mobile stations, the third base station BTS 3 is in communication with the fifth mobile station MS 5 and the fourth base station BTS 4 is in communication with the sixth mobile station MS 6. The first and the second base stations BTS 1 and 2 are connected to a first base station controller BSC 1 whilst the third and fourth base stations BTS 3 and 4 are connected to a second base station controller BSC 2. The first and second base station controllers BSC 1 and 2 are connected to a mobile services switching centre MSSC.

In practice a plurality of mobile services switching centres are provided each of which is connected to a number of base station controllers. Usually more than two base station controllers are connected to a mobile services switching centre. More than two base stations may be connected to each base station controller. Of course many more than two mobile stations will be in communication with a base station.

The decision as to which of the method is used can be taken in any one or more of the network elements shown in FIG. 10. For example, the decision may be made in a mobile station, a base transceiver station, an authentication centre, a mobile services switching centre or the like. Alternatively or additionally, the decision may be taken by any other suitable element. An element dedicated to determining the method to be used may be provided. The trusted third party may be the base station controller, the mobile services switching centre or another element.

Embodiments of the present invention may also be used in other situations which require authentication such as other types of wireless communication or communications which use fixed wire connections. Embodiments of the present invention are not just applicable to communication networks but are also applicable to point to point connections be they wired or wireless connections.

1. An authentication method for authenticating communication between a first and a second party using a third party which is trusted by said first and second parties comprising the steps of:
calculating by the trusted third party the value of a first authentication output using a parameter of the first party and a second authentication output using the first authentication output and sending the second authentication output to the second party;
calculating by the first party the first authentication output and sending the first authentication output to the second party; and
calculating by the second party the second authentication output based on the first authentication output received from the first party and comparing the calculated second authentication output with the second authentication output received from the trusted third party whereby if the two second authentication outputs are the same, the first party is authenticated.

2. A method as claimed in claim 1, wherein the method comprises the steps of calculating by the first party the value of the second authentication output, sending the value of the second authentication output calculated by the trusted third party to said first party and comparing at the first party the calculated value of the second authentication output calculated by the first party and the value of the second authentication output connected by the third party whereby second party is authenticated.

3. A method as claimed in claim 2, wherein the value of the second authentication output calculated by the trusted third party is sent to the first party via the second station.

4. A method as claimed in claim 1,2 or 3, wherein at least one of the first and second authentication outputs are the outputs of a hash function.

5. A method as claimed in claim 4, wherein both of said first and second authentication outputs are the outputs of a hash function and both of said hash functions are one way.

6. A method as claimed in claim 4 or 5, wherein at least one of said hash functions has a value of at least 160 bits in length.

7. A method as claimed in any of claim 4, 5 or 6, wherein one of the hash functions includes a secret which is shared by said first and second parties.

8. A method as claimed in claim 7, wherein said secret comprises a Diffie-Hellman function.

9. A method as claimed in claim 7 or 8, wherein the shared secret is used by at least one party to encrypt communications between the first and second parties.

10. A method as claimed in any one of claim 7, 8 or 9, wherein the shared secret is g^{xy}mod n where g is a Diffie-Hellman function, x and y are random numbers and n is the modulus of the Diffie-Hellman function.

11. A method as claimed in any preceding claim, wherein at least one random number is used to encrypt communications between the first and second parties.

12. A method as claimed in claim 11, wherein rekeying of a encryption function occurs when the at least one random number is changed.

13. A method as claimed in any preceding claim, wherein the value of at least one parameter is sent from the first station to the second station.

14. A method as claimed in any preceding claim, wherein the value of at least one parameter is sent from the second station to the first station.

15. A method as claimed in any preceding claim, wherein the trusted third party has a secure connection with the second party.

16. A method as claimed in any preceding claim, wherein the identity of at least one of said first and second parties is only sent to the other of said f first and second parties in an encoded form.

17. A method as claimed in claim 16, wherein the identity is sent within one of said first and second authentication outputs.

18. A method as claimed in claim 16, wherein the identity is sent in an encrypted form.

19. A method as claimed in any one of the preceding claims, wherein the method is used in a telecommunications network.

20. A method as claimed in claim 19, wherein one of said first and second parties comprises a mobile station.

21. A method as claimed in claim 20 or 21, wherein one of said first and second parties comprises a base station.

22. A first station for communication with a second station using a third party which is trusted by said first station and said second station, said first station comprising:
receiving means for receiving a first authentication output from said second station and a second authentication output from said trusted third party;
calculation means for calculating the second authentication output from the first authentication output received from the second station; and
comparing means for comparing the calculated second authentication output with the second authentication output received from the trusted third party, whereby if the two second authentication outputs are the same, the first party is authenticated.

23. A first station as claimed in claim 22, wherein said first station is a mobile station.

24. A first station as claimed in claim 22, wherein said first station is a base transceiver station.

25. A first station as claimed in claim 22, 23 or 24, wherein said first station receives the second authentication output from the trusted third party via the second station.

26. A wireless telecommunications system comprising a first station as claimed in any of claims 22 to 25 and a second station, wherein said second station is arranged to calculate the first authentication output and to transmit the first authentication output to the first party.
